(19) United States
(12) Patent Application Publication
(10) Pub. No.: US 2005/0082129 A1
(43) Pub. Date: Apr. 21, 2005

(54) Half auto air bleeding cylinder

(76) Inventor: Kyoung Hae Kim, Los Angeles, CA (US)

Correspondence Address: Kyoung Hae Kim, 146 Douglas St. #10, Los Angeles, CA, 90026, US

(21) Appl. No.: 10/690,473

(22) Filed: Oct. 21, 2003

(51) Int. Cl. B60T 11/00

(52) U.S. Cl. 188/352

(57) ABSTRACT

This invention can do air bleeding work more easy way, no more trouble way, so save labor and time. Also solves vapour lock problem easy way. And the air bleeding nipple is stuck up or the working room for moving hand for the air bleeding work is very small or can not reach easy way, so if the air bleeding work is in trouble, half auto air bleeding cylinder solves the trouble easy way and faster. Vapour lock problem is solved fast way, not too long by this half auto air bleeding cylinder.

### BACKGROUND OF INVENTION

I. Field of the Invention

This invention relates to vehicle. Specifically, it relates brake system, especially wheel cylinder air bleeding work and caliper air bleeding work.

II. Background Art

Why we should do air bleeding work, is without air bleeding, if cylinder got air, the vehicle doesn't stop properly and can make accident. So we have to do air bleeding work perfectly. In case of cylinder get the air is wheel cylinder change occasion or wheel cylinder piston cup change or vapour lock occur or caliper change and caliper flexible leaking hose change occasion.

Like these occasion we have to do air bleeding work from the air bleeding nipple. So the air bleeding nipple is frequently stuck up occasion or the vapor lock occur, we have to get trouble time occasion or the working room for moving hand for the air bleeding work is very small or can not reach easily, so like these trouble occasion, in order to save effort and time, we use Half Auto Air Bleeding Cylinder for the more easy way.

### BRIEF SUMMARY OF THE INVENTION

At the Auto repair shop, if the auto mechanic change the wheel cylinder because of the wheel cylinder leaking. After change of the wheel cylinder the auto mechanic should do air bleeding work from the wheel cylinder nipple by loosening and tightening the nipple.
(a) The wheel cylinder nipple when by loosening time one person pushes step on the brake pedal and the other person looses the wheel cylinder nipple.
(b) At this time from the wheel cylinder the air and brake oil bursting come out.
(c) This work is, we can call, “air bleeding work”.
(d) Exact air bleeding work is that one person steps on the brake pedal and repeats a few times.
(e) And holding step on the brake pedal, it gathers the air around the nipple side.
(f) And the other person loosens the nipple, the air and the brake oil bursting come out.
(g) And tighten the nipple, if we do like this work a few times, the air bleeding work is being done.
(h) Like this type of air bleeding is general air bleeding.
   This invention makes air bleeding work more easy way, so save efforts and a lot of times. In case of jumbo air plane, save two hours and six persons' efforts and working.

If with wheel the helicopter is trying to do the air bleeding work, it saves a lot of troubles and time and work, if we use half auto air bleeding cylinder. If in a case of vapour lock occur in the wheel cylinder, half auto air bleeding cylinder solves the problem easy way.
(a) In order to do half auto air bleeding, one person watches out of the master cylinder because brake oil should not be exhausted and keep going filled up the master cylinder.
(b) And the other person select the switch, we call it push down and select switch, whose wheel cylinder is trying to do the air bleeding work.
(c) And then the other person pushes step on the brake pedal a few times, it gathers the air near the air bleeding hole and release the brake pedal.
(d) And pushes, push down and select switch and then electric magnet is working.
(e) And so then the electric magnets withdrawal the blocking two keys from the piston side.
(f) And then pushes step on the brake pedal a few times, at this time keep going on pressing the push down and select switch.
(g) And then the air and oil bursting come out. Because unlocked piston is working.
(h) And then release the brake pedal.
(i) So the big piston is coming down to the end by the spring pressure.
(j) And then release the push down and select switch, and the big piston is locking by the keys reactioning spring.
(k) This is a one time finish air bleeding work and a few times repeat, air bleeding work is accomplished.
(l) Like these way, we can select the wheel, which wheel we have to do air bleeding and then finish every wheels' air bleeding work.

### BRIEF DESCRIPTION OF THE SEVERAL VIEWS OF THE DRAWING

This half auto air bleeding cylinder solves the air bleeding problem faster and easy way.

Drawing Figures

FIG. 1. is the simple drawing for understanding

FIG. 2A, at this drawing, is appeared electric magnets and bullet piston and keys. These things make, half auto air bleeding cylinder, working possible.

FIG. 2.B. shows, push down and select switch, and teach how to work with electric magnet and it's combination working.

FIG. 2.C. shows needle bearing, for more easy way key's sliding.

FIG. 3.A. shows different type of half auto air bleeding cylinder and shows changing magnetic pole and electric magnet field and shows shifting rod how to move by the switch.

FIG. 3.B. shows a little bit different type of FIG. 3.A. by using cable and lever.

Reference Numerals In Drawings

| | | | |
|---|---|---|---|
| 4 | push down switch in the push | | |
| | down and select switch = p.s. | | |
| | switch | | |
| 5 | needle bearing | 6 | electric magnet |
| 7 | spring | 8 | bullet piston |
| 9 | air bleeding hole | 10 | wheel cylinder |
| 11 | disconnecting heat material | 12 | big piston |
| 13 | key = lock key | 14 | stream line, fish type rod |
| | | | every rod is stream line type |
| | | | and got strong little bit of fin |
| | | | just like fish = piston rod |
| 15 | spring | 16 | spring |
| 17 | spring | 18 | select switch in the push down |
| | | | and select switch |
| 19 | push down and select switch | 20 | push down and select switch = |
| | | | p.s. switch |
| 21 | guide of key | 22 | electric magnet |
| 23 | seal | 24 | piston = big piston |
| 25 | key = lock key | 26 | needle bearing |
| 27 | shifting magnetic rod | 28 | piston seat |
| 29 | dust cover hair | | |
| 31 | disconnecting heat material | 32 | top button = push down button, |
| | | | in the plus minus changing |
| | | | push down and select switch |
| 33 | air bleeding hole | 34 | select switch, in the plus minus |
| | | | changing push down and select |
| | | | switch, so we call it P.M.C. |
| | | | push down and select switch. |
| | | | More abbreviation, P.M.C.P.S. |
| | | | switch |
| 35 | double electric wire | 36 | not acme, but long line spiral, so |
| | | | easy way turn |
| 37 | air stuck up hole | 38 | plus minus changing push down |
| | | | and select switch. = P.M.C.P.S. |
| | | | switch |
| 39 | strong spring | 10 | wheel cylinder |
| 40 | piston rod | 41 | lift up and down lever |
| 42 | release lever | 43 | air stuck up hole |
| 44 | air bleeding hole | 45 | piston seat |
| 46 | dust cover hair | 10 | wheel cylinder |
| 47 | strong spring | 48 | light |
| 49 | Wraped on rubber and wire | 50 | Adjusting connection |
| | string cover | | |
| 51 | Just like gasket | 52 | Seal |
| 53 | Dust Cover | 54 | Battery |
| 56 | Supporter | 57 | split line long enough = |
| 58 | Wire | | piston moving distance |
| 59 | double nut. | | |

### DETAILED DESCRIPTION OF THE INVENTION

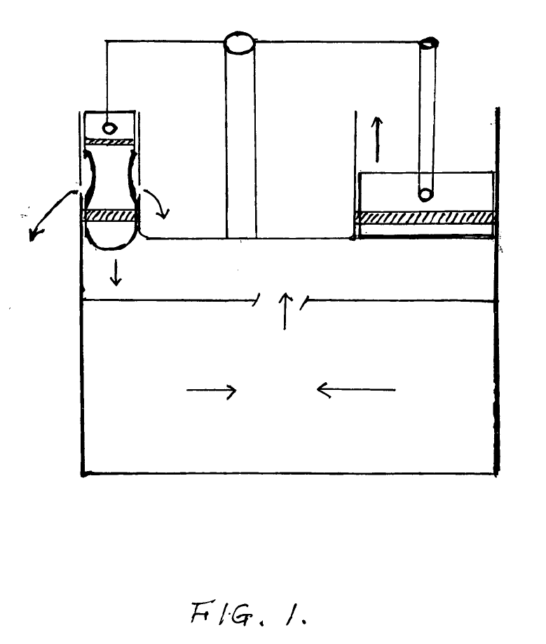

FIG. 1. Shows how to work for air bleeding automatically.

Like this method can be used for any other field.

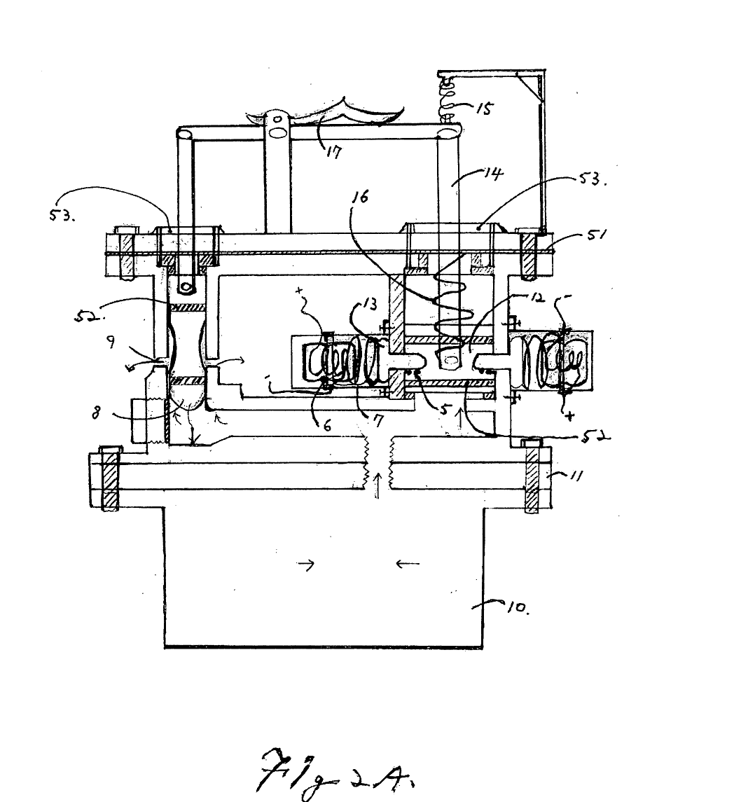

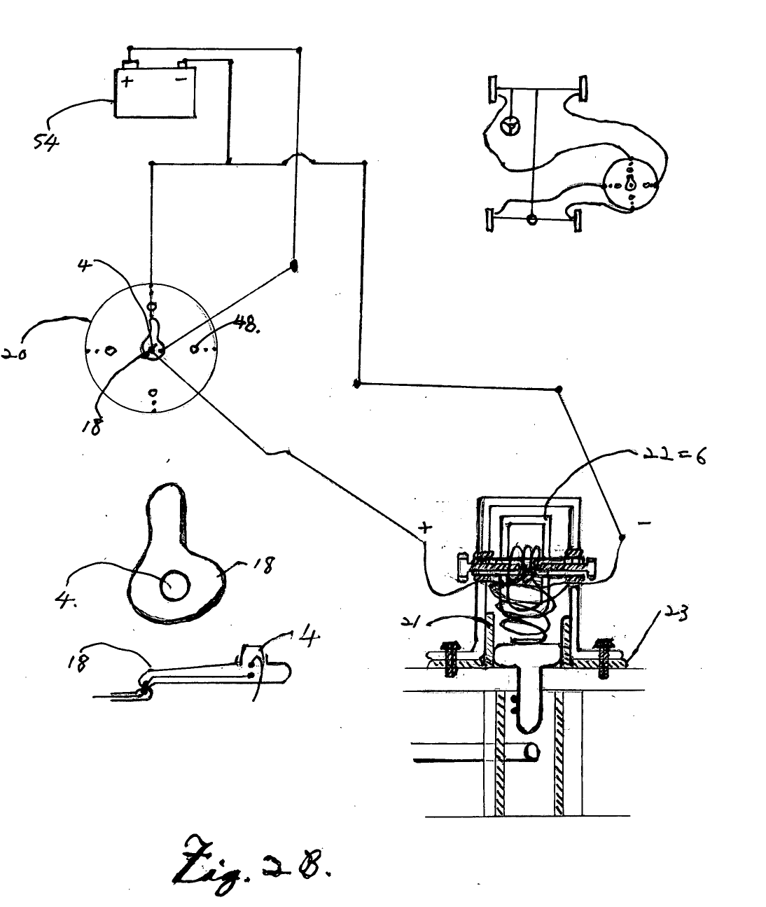

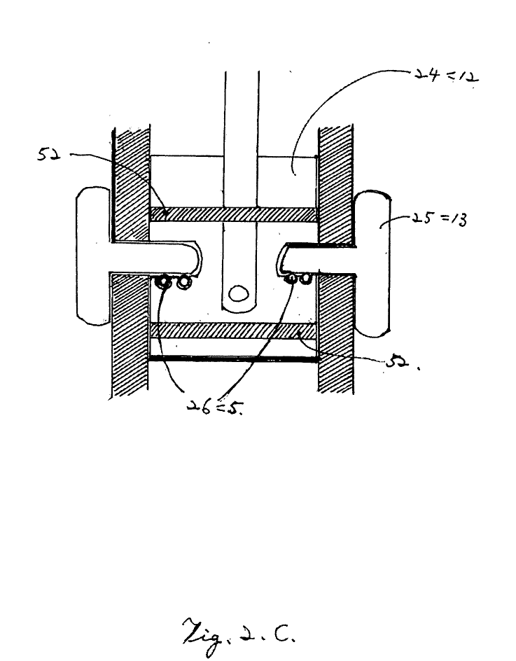

FIG. 2.A. shows half auto air bleeding cylinder. How to work is like these, at first, select 18 which wheel cylinder we want to do air bleeding, and pushes step on the brake pedal a few times, and release brake pedal, the air gather together near 8 head. And then pushes 4 and keep going on pushing down, 6 is working and 13 is withdrawaled from 12. Right this time pushes step on the brake pedal, 12 and 14 goes up in spite of 17, 15, 16 pressure and 8 come down and the air with the brake oil bursting come out from 9 and then release the brake pedal and release 4=20. 12 and 14 is coming down by 17, 15, 16 and after 12 is right back at that position, 12 is locked by 13. At this time 13 is moving by 7, and 12 is locked by 13. And this is a one time air bleeding work accomplished. And so we can do a few times repeat, the air bleeding work is done.

From the beginning of the air bleeding work, brake master cylinder cover should be opened and be filled with brake oil enough and should be checked not to be exhausted.

FIG. 2.B. shows how to work 20 and working 6. If we need air bleeding from right rear wheel, we can select and can do air bleeding work. If we want to see 6 is working, select 18 which wheel we need air bleeding and push down 4.

6 is working, and it makes that 13 is withdrawled from 12.

FIG. 2.C. shows that 25=13 easy way come inside 24=12, the cause is 26=5, and 24 is easy way locked and open by 25.

### DETAILED DESCRIPTION OF THE INVENTION

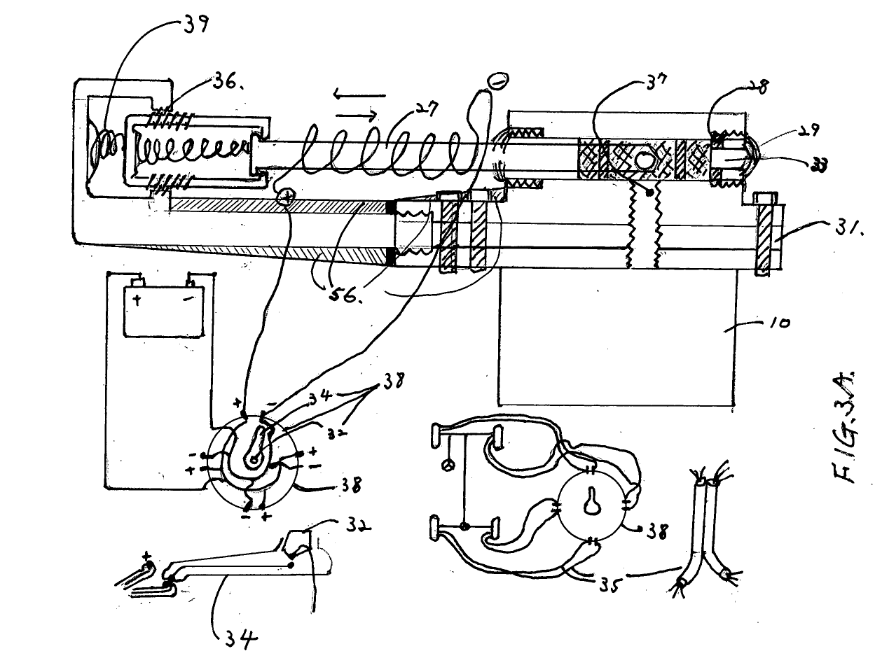

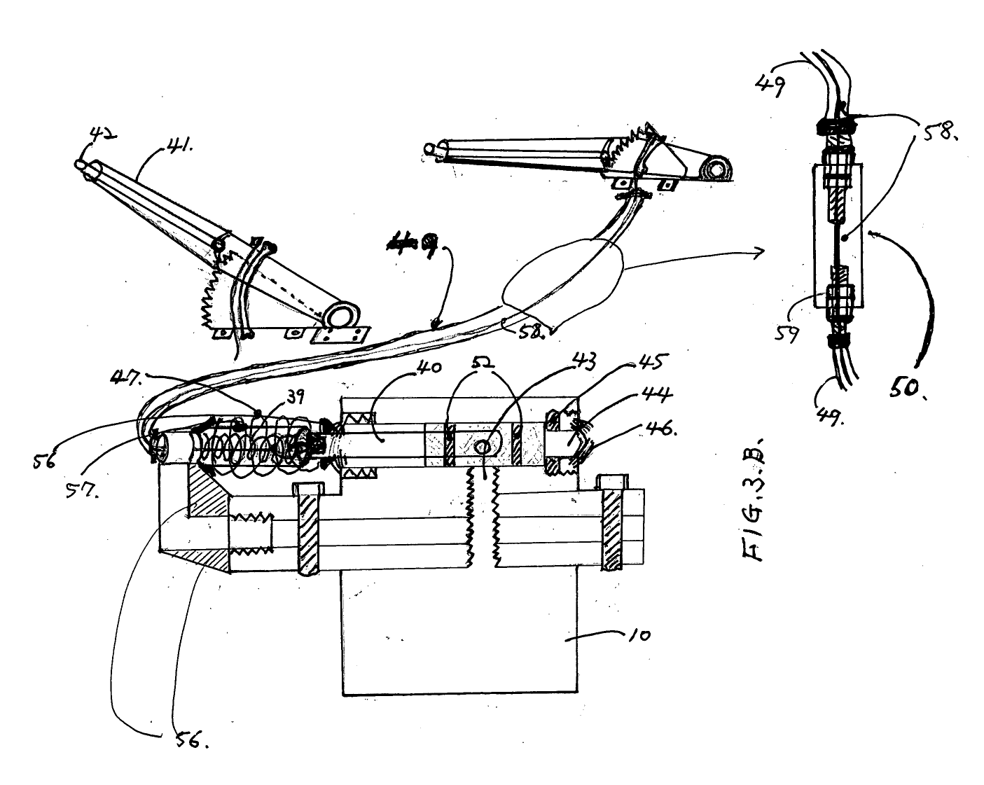

FIG. 3.A. shows different type of FIG. 2.A. How to work is like these, at first, pushes step on the brake pedal a few times and select 34 which wheel we have to do air bleeding. And keep going on pushing 32, and 27 moves left side because of electric magnetic field and 37 is opened and then again pushes step on the brake pedal a few times the air and oil bursting come from 33. And then change electric magnetic pole changing minus to plus by 34, it makes 27 goes back right at that position, and release brake pedal and release 32.37 is closed and 33 is closed. And pushes step on the brake pedal a few times and holding step on the brake pedal properly and press 32 and keep going on pressing, it makes 27 move left side for opening 37 hole and 33. As soon as press 32, 27 moves left side 37 hole and 33 hole is opened, and then air and oil bursting come out from 37 through 33 hole, because holding step on the brake pedal. In spite of holding step on the brake pedal, 27 moves left side because electric magnetic field is strong enough. And then change electric magnetic pole changing minus to plus by 34, it makes 27 goes back right at that position, 37 is closed and 33 is closed. And release 32, and release brake pedal. So half auto air bleeding work is accomplished. And then repeat this work a few times, half auto air bleeding work is perfect finish.

### DETAILED DESCRIPTION OF THE INVENTION

FIG. 3.B. shows a little bit different type of FIG. 3.A, using that different elements is added. How to work is like these, at first, pushes step on the brake pedal a few times and holding step on the brake pedal properly and lifts up 41 in spite of 47, 39 pressure 40 moves left side and, the air and oil bursting come out from 43 to 44 and a little bit lift up 41 and push down 42 and absolutely down 41 and then by 47, 39 and 40 goes back right at that position. This is a one time air bleeding accomplished and repeat a few times, the air bleeding work is accomplished.

### CONCLUSION, RAMIFICATIONS, AND SCOPE

Wheel cylinder change occasion or wheel cylinder piston cup change or vapour lock occur or caliper change and caliper flexible leaking hose change occasion, like these occasion we have to do air bleeding work from the air bleeding nipple.

So the air bleeding nipple is frequently stuck up occasion or the vapour lock occur, we have to get trouble time occasion or the working room for moving hand for the air bleeding work is very small or can not reach easily, so like these trouble occasion, in order to save efforts and time, we use half auto air bleeding cylinder.

This invention makes air bleeding work more easy way, so save efforts and a lot of time. In case of jumbo air plane, can save two hours and six persons' efforts and working.

With wheel the helicopter is trying to do the air bleeding work, save a lot of trouble and time and work.

1. In a air bleeding work, wherein said half auto air bleeding cylinder solves trouble time and efforts easy way, even faster.

2. In a case of fighting air plane, come back and hurry up, go to fighting back because of solving wherein said vapour lock problem easy way.

3. In case of wherein said jumbo air plane, get a lot of economic profits because of saving trouble time and working man in wherein said air bleeding work.

4. With wheel helicopter is in emergency time, easy way wherein said air bleeding work is accomplished.

5. In case of space ship, as soon as space ship is landed, escaping any other problem, wherein said half auto air bleeding cylinder solves vapour lock problem without any trouble time and without long waiting time and any efforts, but easy way.
